(19) United States
(12) Patent Application Publication
(10) Pub. No.: US 2016/0279731 A1
(43) Pub. Date: Sep. 29, 2016

(54) Blank Forming Device Using Electric Direct Heating Method

(71) Applicant: HYUNDAI MOTOR COMPANY, Seoul (KR)

(72) Inventor: Jae Ryeon Hwang, Ulsan (KR)

(73) Assignee: HYUNDAI MOTOR COMPANY, Seoul (KR)

(21) Appl. No.: 14/853,339

(22) Filed: Sep. 14, 2015

(30) Foreign Application Priority Data
Mar. 25, 2015 (KR) 10 2015 0041784

(51) Int. Cl. B23K 11/30; H05B 3/02; B21D 39/03; H05B 3/03

(52) U.S. Cl. CPC B23K 11/3009; H05B 3/03; H05B 3/023; B21D 39/03; B23K 2201/006

(57) ABSTRACT

The present disclosure provides a blank forming device which includes: first and second blanks to be loaded at one side in a width direction and unloaded at the other side in the width direction; an upper electrode and a lower electrode to contact upper portions and lower portions of one side of the loaded first and second blanks; an upper moving electrode and a lower moving electrode to contact upper portions and lower portions of the other side of the first and second blanks and movably disposed in a length direction of the first and second blanks; and a sagging preventing part being disposed at the lower portions of the first and second blanks between the upper electrode and the upper moving electrode and between the lower electrode and the lower moving electrode to let the first and second blanks support sagged portions upward.

### CROSS-REFERENCE TO RELATED APPLICATION

This application claims the benefit of Korean Patent Application No. 10-2015-0041784, filed on Mar. 25, 2015, which is hereby incorporated by reference in its entirety.

### FIELD

The present disclosure relates to a blank forming device using an electric direct heating method for directly applying electricity to a blank for making a vehicle body to heat the blank and forming the blank using a mold.

### BACKGROUND

The statements in this section merely provide background information related to the present disclosure and may not constitute prior art.

Keeping pace with improving fuel consumption and weight reduction of a vehicle, increased strengthening of vehicle parts has been continuously undertaken.

Further, due to structural characteristics of each part of the vehicle, some parts may require high strength and other parts may require high impact toughness.

Typically, vehicle parts having heterogeneous strength have been manufactured by a method of manufacturing parts requiring high strength using a quenched steel sheet and parts requiring relatively lower strength using a general steel sheet and then bonding between these parts by welding.

Meanwhile, a method of heating a blank (steel sheet) using a heating furnace requires a space for the heating furnace. However, it is not easy to heat a portion of the blank using the heating furnace and maintenance costs for operating the heating furnace are high. As the related art, there is Korean Patent Publication No. 10-2011-0075732.

The above information disclosed in this Background section is only for enhancement of understanding of the background of the present disclosure and therefore it may contain information that does not form the prior art that is already known in this country to a person of ordinary skill in the art.

### SUMMARY

The present disclosure provides a blank forming device using an electric direct heating method capable of saving a space required for a heating furnace, easily heating a portion of the blank, saving maintenance costs, and improving productivity.

An exemplary form of the present disclosure provides a blank forming device using an electric direct heating method, including: first and second blanks configured to be loaded at one side in a width direction and unloaded at the other side in the width direction; an upper electrode and a lower electrode configured to contact upper portions and lower portions of one side of the loaded first and second blanks; an upper moving electrode and a lower moving electrode configured to contact upper portions and lower portions of the other side of the first and second blanks and movably disposed in a length direction of the first and second blanks; and a sagging preventing part configured to be disposed at the lower portions of the first and second blanks between the upper electrode and the upper moving electrode and between the lower electrode and the lower moving electrode to let the first and second blanks support sagged portions upward.

The blank forming device may further include: an upper cover configured to be fixedly disposed over the upper electrode and the upper moving electrode; a chiller configured to be disposed over the upper cover to supply a coolant to a circumference of the electrodes; a transformer configured to be disposed over the upper cover to supply a voltage to the electrodes; and a bus bar configured to be disposed on the upper cover to connect between the transformer and each of the electrodes.

The blank forming device may further include a moving part configured to move the upper moving electrode and the lower moving electrode in the length direction of the first and second blanks.

The blank forming device may further include a pressing part configured to press the upper electrode or the lower electrode to the first and second blanks and press the upper moving electrode or the lower moving electrode to the first and second blanks.

The moving part may include: a motor configured to provide a torque; a lead screw configured to rotate by a rotation of the motor; a reference frame configured to be disposed to move by a rotation of the lead screw; a moving frame configured to be disposed at one side of the reference frame and that has the lower moving electrode disposed thereabove; and a tension control cylinder configured to control a position of the moving frame based on the reference frame to control a tension applied to the first and second blanks.

The blank forming device may further include a brake configured to stop the rotation of the lead screw rotating by the motor.

The blank forming device may further include: a moving rail configured to be disposed in a direction in which the upper moving electrode or the lower moving electrode moves to supply power to the upper moving electrode or the lower moving electrode and guide motions thereof; and a shunt configured to be directly connected to the upper moving electrode or the lower moving electrode in the moving rail to apply a current.

The sagging preventing part may include: a sagging preventing cylinder configured to provide a force for supporting the first and second blanks upward; a plate configured to be disposed to move upward by the sagging preventing cylinder; and support protrusions configured to be disposed on the plate to contact lower surfaces of the first and second blanks.

The plate may be disposed on a moving rail to move in a direction in which the first and second blanks move, and the sagging preventing cylinder may have a linear bearing disposed thereunder to move in the length direction of the first and second blanks.

The support protrusions may be arranged at a predetermined interval, and may be made from a material having lower hardness than that of the first and second blanks to prevent the first and second blanks from being damaged.

The first and second blanks may be loaded at one side of the width direction thereof and unloaded at the other side in the width direction thereof.

Another form of the present disclosure provides a blank forming method using an electric direct heating method, including: loading the blank through an inlet of a blank forming device; pressing an electrode on upper and lower surfaces of one side and the other side of the blank and applying a current through the blank; stopping the application of current and releasing the pressing of the electrode; releasing the pressing of the electrode and supporting a lower surface of a central portion of the blank to prevent the lower surface of the blank from sagging; and unloading the blank through an outlet of the blank forming device.

In the applying of a current through the blank, the electrode may move in a length direction of the blank to control a tension of the blank in a state in which the electrode presses the blank.

In the loading of the blank, at least two blanks may be input.

The blank forming method may further include: performing a braking operation of making the electrode move in the length direction of the blank and fixing a motion of the electrode.

According to an exemplary form of the present disclosure, it is possible to save the space required for the heating furnace, easily heat a portion of the blank, save the maintenance costs, and improve the productivity.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a blank forming device using an electric direct heating method according to an exemplary form of the present disclosure;

FIG. 2 is a partial perspective view of a moving part and a tension control part in the blank forming device using an electric direct heating method according to the exemplary form of the present disclosure;

FIG. 3 is a partial perspective view of a sagging preventing part in the blank forming device using an electric direct heating method according to the exemplary form of the present disclosure; and

FIG. 4 is a flowchart of a forming order of the blank forming device according to the exemplary form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

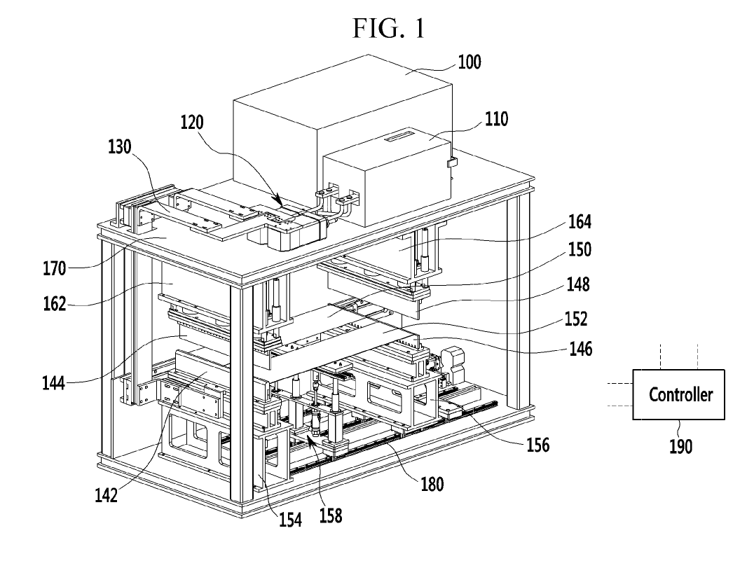

FIG. 1 is a perspective view of a blank forming device using an electric direct heating method according to an exemplary form of the present disclosure.

Referring to FIG. 1, the blank forming device includes a transformer 120, a bus bar 130, an upper cover 170, a fixed electrode pressing part 162, an upper electrode 144, a lower electrode 142, a fixed frame 154, a sagging preventing part 158, a first blank 150, a second blank 152, a frame moving rail 180, a moving frame 156, a lower moving electrode 146, an upper moving electrode 148, a moving electrode pressing part 164, an inverter 110, a chiller 100, and a controller 190.

The lower electrode 142 is disposed at a predetermined interval from the lower moving electrode 146 in a length direction, and the upper electrode 144 and the upper moving electrode 148 are positioned over the lower electrode 142 and the lower moving electrode 146, corresponding to the lower electrode 142 and the lower moving electrode 146.

The fixed electrode pressing part 162 is disposed to press the upper electrode 144 downward and the moving electrode pressing part 164 is disposed to press the upper moving electrode 148 downward.

The moving frame 156 is disposed to reciprocate in a length direction along with the lower moving electrode 146, the upper moving electrode 148, and the moving electrode pressing part 164, and the lower electrode 142 is disposed over the fixed frame 154.

The bus bar 130, the transformer 120, the inverter 110, and the chiller 100 are each disposed over the upper cover 170, and the chiller 100 includes a coolant which cools the circumference of the upper electrode 144, the lower electrode 142, the upper moving electrode 148, and the lower moving electrode 146, and circulates the coolant to a circumference of the electrodes.

Further, power supplied to the inverter 110 is supplied to the electrodes through the transformer 120 and the bus bar 130.

According to the exemplary form of the present disclosure, the sagging preventing part 158 and the moving frame 156 are adjusted to a predetermined position along the frame moving rail 180 before the first and second blanks 150 and 152 are loaded, and the first and second blanks 150 and 152 are loaded at one side in a width direction in parallel with each other.

The first and second blanks 150 and 152 are disposed over the lower electrode 142 and the lower moving electrode 146, and the upper electrode 144 and the upper moving electrode 148 each descend by the fixed electrode pressing part 162 and the moving electrode pressing part 164 and are pressed to upper surfaces of both ends of the first and second blanks 150 and 152.

When the first and second blanks 150 and 152 are heated with a current, the moving frame 156 moves to absorb the thermal expansion of the first and second blanks 150 and 152, thereby applying a constant tension to the first and second blanks 150 and 152. Further, after the first and second blanks 150 and 152 are heated, the sagging preventing part 158 prevents middle portions of the first and second blanks 150 and 152 from sagging downward.

The controller 190 controls a driver and a power supply unit for each component, the controller 190 may be implemented as at least one microprocessor executed by a predetermined program, and the predetermined program may include a series of commands for executing a method according to an exemplary form of the present disclosure to be described below.

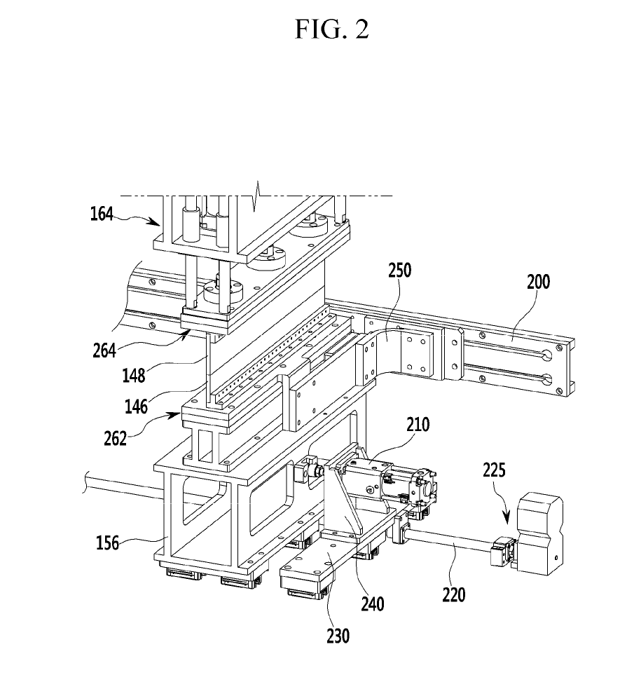

FIG. 2 is a partial perspective view of a moving part and a tension control part in the blank forming device using an electric direct heating method according to the exemplary form of the present disclosure.

Referring to FIG. 2, the moving electrode pressing part 164 is disposed at an upper portion, an upper electrode holder 264 is disposed thereunder, and the upper moving electrode 148 is fixed to the upper electrode holder 264.

The lower moving electrode 146 is disposed at a position corresponding to the upper moving electrode 148, a lower electrode holder 262 is disposed thereunder, and the lower moving electrode 146 is fixed to the lower electrode holder 262.

The moving frame 156 is disposed under the lower electrode holder 262, and the moving frame 156 is disposed to move along the frame moving rail 180 through a linear bearing thereunder. In this configuration, the moving electrode pressing part 164 is also disposed to move along a rail along with the moving frame 156.

A reference frame 230 is disposed under one side of the moving frame 156, and a tension control cylinder 210 is disposed over the reference frame 230 through a bracket 240. The tension control cylinder 210 may push or pull the moving frame 156 based on the reference frame 230 to control a tension applied to the first and second blanks 150 and 152.

According to the exemplary form of the present disclosure, the reference frame 230 is disposed to reciprocate in the length direction by the rotation of a lead screw 220, and the lead screw 220 has a structure rotating by a frame moving part 225.

The frame moving part 225 includes a motor and a deceleration mechanism, and may include a brake for fixing a rotating position of the lead screw 220. Here, the brake may directly fix a motion of the reference frame 230.

An electrode moving rail 200 is disposed at one side of the moving frame 156 in a length direction, a current flows through the electrode moving rail 200, and the current flowing the electrode moving rail 200 is applied to the lower electrode holder 262 and the lower moving electrode 146 through a shunt 250.

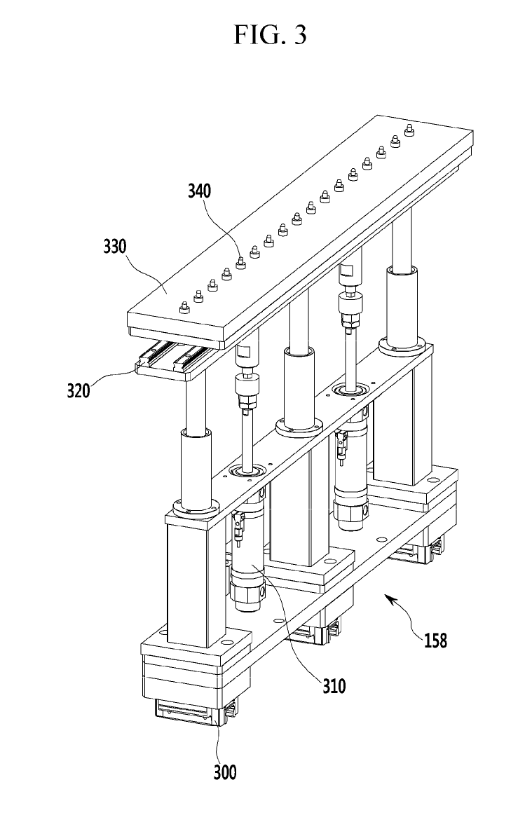

FIG. 3 is a partial perspective view of a sagging preventing part in the blank forming device using an electric direct heating method according to the exemplary form of the present disclosure.

Referring to FIG. 3, the sagging preventing part 158 is disposed to move in a length direction on the frame moving rail 180 through a linear bearing 300, and a sagging preventing cylinder 310 is vertically disposed on the linear bearing 300.

A plate moving rail 320 and a plate 330 are disposed on the sagging preventing cylinder 310, and blank support protrusions 340 are arranged on the plate 330 in one direction.

The plate 330 may reciprocate in a width direction of the first and second blanks 150 and 152 along the plate moving rail 320, and the plate moving rail 320 and the plate 330 may vertically move by the sagging preventing cylinder 310.

The blank support protrusions 340 may be made from a rubber material or a plastic material to prevent the first and second blanks 150 and 152 from being scratched, and may be made from a material having lower hardness than that of the first and second blanks 150 and 152 among metal materials.

According to the exemplary form of the present disclosure, a cylinder is operated by air pressure, oil pressure, or an electric motor.

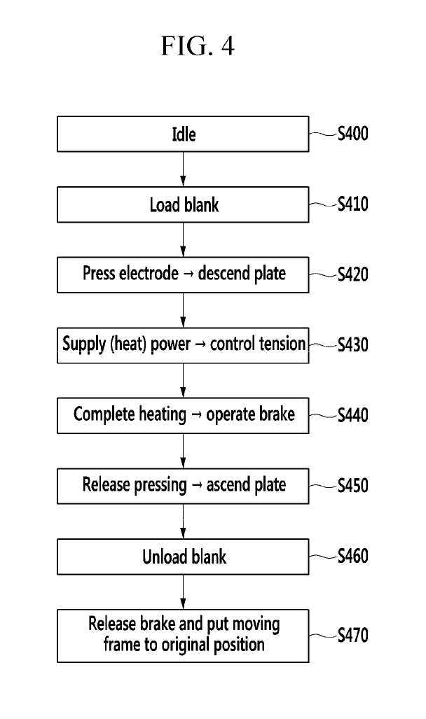

FIG. 4 is a flowchart of a forming order of the blank forming device according to the exemplary form of the present disclosure.

Referring to FIG. 4, in S400, a supply of power is prepared and an operation of all drivers is prepared. Here, positions of the upper moving electrode 148 and the lower moving electrode 146 return to set positions and the upper electrode 144 and the upper moving electrode 148 return to set height positions. Further, the plate 330 of the sagging preventing part 158 returns to a predetermined height position.

In S410, the first and second blanks 150 and 152 are loaded together, and in S420, the upper electrode 144 and the upper moving electrode 148 descend by the moving electrode pressing part 164 to adhere to the first and second blanks 150 and 152. In this case, the plate 330 descends.

In S430, power is applied to the electrodes by the inverter 110 and the transformer 120, and a tension applied to the first and second blanks 150 and 152 is controlled by the tension control cylinder 210.

If it is determined that heating is completed, in S440, power supplied to the electrode is cut off and the brake for fixing the motion of the moving frame 156 is operated.

In S450, the upper electrode 144 and the upper moving electrode 148 ascend by the moving electrode pressing part 164 and the plate 330 ascends to prevent the first and second blanks 150 and 152 from sagging.

Further, in S460, the first and second blanks 150 and 152 are unloaded, and in S470, the brake for fixing the moving frame 156 is released and the moving frame 156 returns to a predetermined position.

While this present disclosure has been described in connection with what is presently considered to be practical exemplary forms, it is to be understood that the present disclosure is not limited to the disclosed forms. On the contrary, it is intended to cover various modifications and equivalent arrangements included within the spirit and scope of the appended claims.

<Description of symbols>

| | |
|---|---|
| 100: Chiller | 110: Inverter |
| 120: Transformer | 130: Bus bar |
| 142: Lower electrode | 144: Upper electrode |
| 146: Lower moving electrode | 148: Upper moving electrode |
| 150: First blank | 152: Second blank |
| 154: Fixed frame | 156: Moving frame |
| 158: Sagging preventing part | 162: Fixed electrode pressing part |
| 164: Moving electrode pressing part | 170: Upper cover |
| 180: Frame moving rail | 190: Controller |
| 200: Electrode moving rail | 210: Tension control cylinder |
| 220: Lead screw | 225: Frame moving part |
| 230: Reference frame | 240: Bracket |
| 250: Shunt | 262: Lower electrode holder |
| 264: Upper electrode holder | 300: Linear bearing |
| 310: Sagging preventing cylinder | 320: Plate moving rail |
| 330: Plate | 340: Blank support protrusion |

What is claimed is:

1. A blank forming device using an electric direct heating method, comprising:
first and second blanks configured to be loaded at one side of the blanks in a width direction and unloaded at another side of the blanks in the width direction;
an upper electrode and a lower electrode configured to contact upper portions and lower portions of one side of the loaded first and second blanks;
an upper moving electrode and a lower moving electrode configured to contact upper portions and lower portions of the other side of the first and second blanks and movably disposed in a length direction of the first and second blanks; and
a sagging preventing part configured to be disposed at the lower portions of the first and second blanks between the upper electrode and the upper moving electrode and between the lower electrode and the lower moving electrode to let the first and second blanks support sagged portions upward.

2. The blank forming device according to claim 1, further comprising:
an upper cover configured to be fixedly disposed over the upper electrode and the upper moving electrode;
a chiller configured to be disposed over the upper cover to supply a coolant to a circumference of at least one of the upper electrode, the lower electrode, the upper moving electrode and the lower moving electrode;
a transformer configured to be disposed over the upper cover to supply a voltage to at least one of the upper electrode, the lower electrode, the upper moving electrode and the lower moving electrode; and
a bus bar configured to be disposed on the upper cover to connect between the transformer and each of the upper electrode, the lower electrode, the upper moving electrode and the lower moving electrode.

3. The blank forming device according to claim 1, further comprising
a moving part configured to move the upper moving electrode and the lower moving electrode in the length direction of the first and second blanks.

4. The blank forming device according to claim 3, further comprising
a pressing part configured to press the upper electrode or the lower electrode to the first and second blanks and press the upper moving electrode or the lower moving electrode to the first and second blanks.

5. The blank forming device according to claim 3, wherein
the moving part comprises:
a motor configured to provide a torque;
a lead screw configured to rotate by a rotation of the motor;
a reference frame configured to be disposed to move by a rotation of the lead screw;
a moving frame configured to be disposed at one side of the reference frame and has the lower moving electrode disposed thereabove; and
a tension control cylinder configured to control a position of the moving frame based on the reference frame to control a tension applied to the first and second blanks.

6. The blank forming device according to claim 5, further comprising
a brake configured to stop the rotation of the lead screw.

7. The blank forming device according to claim 1, further comprising:
a moving rail configured to be disposed in a direction in which the upper moving electrode or the lower moving electrode moves to supply power to the upper moving electrode or the lower moving electrode and guide motions thereof; and
a shunt configured to be directly connected to the upper moving electrode or the lower moving electrode in the moving rail to apply a current.

8. The blank forming device according to claim 1, wherein
the sagging preventing part comprises:
a sagging preventing cylinder configured to provide a force for supporting the first and second blanks upward;
a plate configured to be disposed to move upward by the sagging preventing cylinder; and
support protrusions configured to be disposed on the plate to contact lower surfaces of the first and second blanks.

9. The blank forming device according to claim 8, wherein
the plate is disposed on a moving rail to move in a direction in which the first and second blanks move, and the sagging preventing cylinder has a linear bearing disposed thereunder to move in the length direction of the first and second blanks.

10. The blank forming device according to claim 8, wherein
the support protrusions are arranged at a predetermined interval and are made from a material having lower hardness than that of the first and second blanks to prevent the first and second blanks from being damaged.

11. A blank forming method using an electric direct heating method, comprising:
loading a blank through an inlet of a blank forming device;
pressing an electrode on upper and lower surfaces of one side and other side of the blank and applying a current through the blank;
stopping the application of the current and releasing the pressing of the electrode;
releasing the pressing of the electrode and supporting a lower surface of a central portion of the blank to prevent the lower surface of the blank from sagging; and
unloading the blank through an outlet of the blank forming device.

12. The blank forming method according to claim 11, wherein,
during the applying of a current through the blank, the electrode moves in a length direction of the blank to control a tension of the blank in a state in which the electrode presses the blank.

13. The blank forming method according to claim 11, wherein
in the loading of the blank, at least two blanks are input.

14. The blank forming method according to claim 11, further comprising
performing a braking operation of making the electrode move in a length direction of the blank and fixing a motion of the electrode.
